(19) United States
(12) Patent Application Publication
(10) Pub. No.: US 2021/0216869 A1
(43) Pub. Date: Jul. 15, 2021

(54) DEVICE AND COMPUTER-IMPLEMENTED METHOD FOR DATA-EFFICIENT ACTIVE MACHINE LEARNING

(71) Applicant: Robert Bosch GmbH, Stuttgart (DE)

(72) Inventor: Christian Haase-Schuetz, Fellbach (DE)

(21) Appl. No.: 17/142,930

(22) Filed: Jan. 6, 2021

(30) Foreign Application Priority Data
Jan. 14, 2020 (DE) 102020200356.4

(51) Int. Cl. G06N 3/08; G06F 17/18; G06N 3/04

(52) U.S. Cl. CPC G06N 3/08; G06N 3/04; G06F 17/18

(57) ABSTRACT

A device and a computer-implemented method for data-efficient active machine learning. Annotated data are provided. A model is trained for a classification of the data as a function of the annotated data. For unannotated data, values of an acquisition function of the unannotated data are determined, and the unannotated data for the active machine learning whose values for the acquisition function satisfy a criterion are acquired from the unannotated data. An autocorrelation is determined via a feature representation for a sample from the unannotated data to be assessed, in particular from at least one layer of the model. The value of the acquisition function of this sample is determined as a function of a root mean square via the autocorrelation, in particular in at least one dimension.

### CROSS REFERENCE

The present application claims the benefit under 35 U.S.C. § 119 of German Patent Application No. DE 102020200356.4 filed on Jan. 14, 2020, which is expressly incorporated herein by reference in its entirety.

### FIELD

The present invention is directed to a device and a computer-implemented method for data-efficient active machine learning. Deep neural networks are used for this purpose, among other things.

### BACKGROUND INFORMATION

Deep neural networks deliver predictions for samples and an estimate of an uncertainty of these predictions. The estimate of the uncertainty of the predictions delivered by deep neural networks may be inadequate for certain applications. In particular for samples outside the training set, the associated estimate is often overconfident.

Reliable uncertainties are essential for safety-critical applications such as autonomous driving or medical applications.

### SUMMARY

Reliable uncertainties may be determined using the computer-implemented method and the device according to example embodiments of the present invention.

In accordance with an example embodiment of the present invention, the computer-implemented method for active machine learning provides that annotated data are provided, a model being trained for a classification of the data as a function of the annotated data, for unannotated data, values of an acquisition function of the unannotated data being determined, and the unannotated data for the active machine learning whose values for the acquisition function satisfy a criterion being acquired from the unannotated data, an autocorrelation being determined via a feature representation for a sample from the unannotated data to be assessed, in particular from at least one layer of the model, the value of the acquisition function of this sample being determined as a function of a root mean square via the autocorrelation, in particular in at least one dimension. For an at least partially trained model, the extent to which a given situation differs from the training set may be satisfactorily assessed as a function of the root mean square.

A set of unannotated data is preferably provided, a subset being selected from the set of unannotated data, the annotated data being determined from the subset by in particular manual, semi-automatic, or automatic annotation of unannotated data.

The subset preferably includes the acquired unannotated data for the active machine learning.

For the sample to be assessed, the autocorrelation may be determined via a plurality of feature representations of various layers of the model. This allows a particularly good estimate of the reliability of the prediction of the model for the sample to be assessed.

It is preferably provided that the samples whose root mean square exceeds a threshold value are acquired from the unannotated data. These unannotated data are particularly well suited for the further training.

The threshold value is preferably determined as a function of at least one sample from the annotated data with which the model is trained. The annotated data allow a threshold value to be specified that is well suited for the acquisition of unannotated data.

The model may be iteratively trained, a check being made as to whether an abort criterion is satisfied, and the active machine learning being ended when the abort criterion is satisfied. This successively improves the accuracy of the classification.

The abort criterion preferably defines a reference for an accuracy of the classification of annotated or unannotated data by the model, the abort criterion being satisfied when the accuracy of the classification reaches or exceeds the reference. The uncertainty is reduced in this way.

Unannotated data may be randomly selected in a first iteration of the method for a determination of the annotated data.

Preferably only data that are not already acquired for the subset are selected from the unannotated data for the subset.

In one aspect of the present invention, for a model trained in this way, in particular an artificial neural network trained in this way, as a function of the root mean square it is established via the autocorrelation whether the sample to be assessed differs from a sample from a training set of samples with which the thus-trained model has been trained.

In accordance with an example embodiment of the present invention, a device for active machine learning is designed to carry out the method.

Further advantageous specific embodiments of the present invention result from the following description and the figures.

### BRIEF DESCRIPTION OF THE DRAWINGS

FIG. 1 shows a schematic illustration of a device for active machine learning, in accordance with an example embodiment of the present invention.

FIG. 2 shows steps in a method for active machine learning, in accordance with an example embodiment of the present invention.

### DETAILED DESCRIPTION OF EXAMPLE EMBODIMENTS

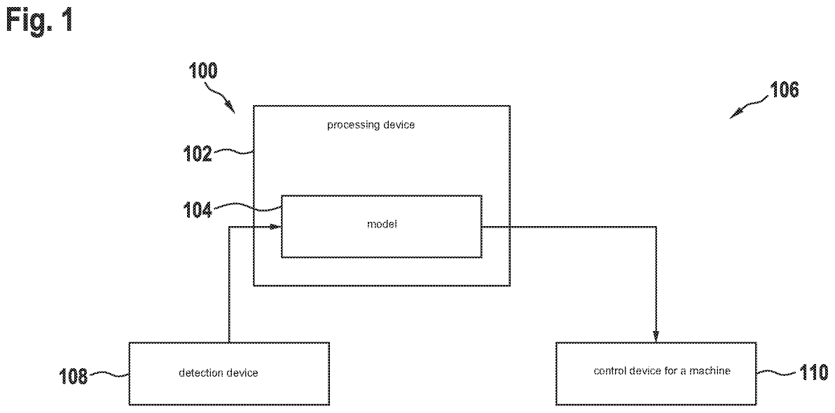

Device 100 for active machine learning illustrated in FIG. 1 is designed to carry out a method described below, in accordance with an example embodiment of the present invention.

Device 100 includes a processing device 102, in particular one or multiple processors, and at least one memory for data. Device 100 includes a model 104.

Device 100 may be designed for digital image processing in which digital images are classified by model 104. In the following discussion, an acquisition function that is based on model 104 is used. In the example, model 104 is a single deep neural network. Model 104 may also be formed from multiple in particular deep neural networks, or may have some other architecture.

A system 106 for machine learning may include device 100, a detection device 108 for detecting digital images, and a control device 110 for a machine. System 106 may be designed to control the machine into a class of multiple classes as a function of a classification of a detected digital image. The machine may be a vehicle or a robot. Instead of a classification of digital images, classification for a detection of objects in sensor measurements or for voice-to-text conversions may be provided. Instead of detecting digital images, general sensor measurements, such as 3D sensor measurements by radar or LIDAR sensors, for example, may be used.

In a training of system 106, detection device 108 may detect a situation that is represented by a digital image.

In the use of system 106, detection device 108 may detect a situation that differs from the situation that was used for training model 104. In the use of system 106, situations may be detected that are different from the situations that were used in the training. For detecting these situations, a function, described below, is used which encompasses a root mean square RMS of an autocorrelation AC via a feature representation F of a sample in already trained neural network M. This function is an information-theoretic measure for the information content of a numerical sequence. Based on the acquisition function, situations may be detected during application that are very different from the situations for which the neural network was trained, even for a completely trained neural network. This allows an estimate of the reliability of the predictions of the trained neural network. For a low reliability, this information is taken into account in the control by control device 110.

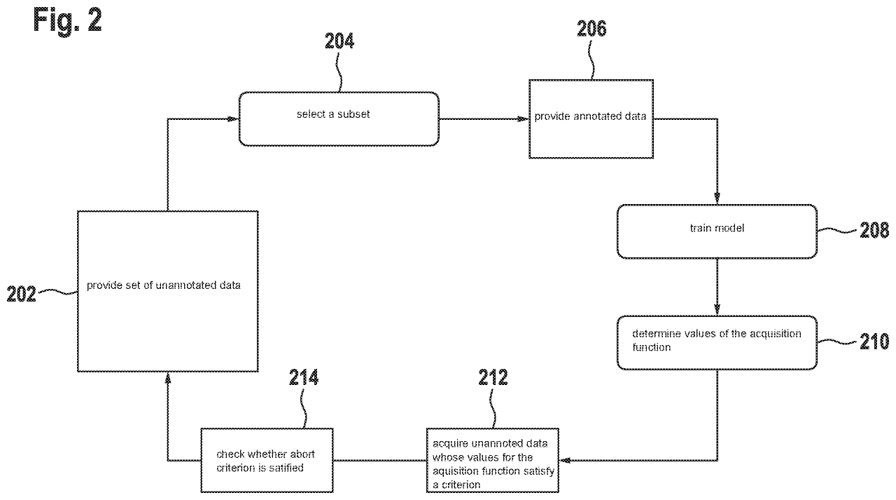

A computer-implemented method for active machine learning in accordance with an example embodiment of the present invention is described with reference to FIG. 2. Model 104 is trained using the method, and may be subsequently used in system 106. The method assumes that the architecture of model 104 is fixed and parameters of model 104 are already initialized. In the example, model 104 is a deep neural network whose hyperparameter defines an input layer, an output layer, and a plurality of concealed layers in between. The parameters of the deep neural network are determined as follows.

In the example, one of the following functions is used as an acquisition function. The acquisition function described below is the root mean square RMS of an autocorrelation AC via a feature representation F of a sample, i.e., a sample in an at least partially trained neural network M encompassed by model 104. This function is an information-theoretic measure for the information content of a numerical sequence. Based on the acquisition function, situations may be detected during application that are very different from the situations for which the neural network was trained, even for a completely trained neural network. This allows an estimate of the reliability of the predictions of the trained neural network.

Autocorrelation AC of a signal Y for a given “time lag” τ in one dimension is given by

$$AC [ Y ] ( τ ) = \frac{\frac{1}{{N}_{τ}} {\sum }_{i} ( {y}_{i + τ} - μ ) ( {y}_{i} - μ )}{\frac{1}{{N}_{τ}} {\sum }_{i} {( {y}_{i} - μ )}^{2}}$$

where the average value is μ. In two dimensions, the autocorrelation is given by

$${AC}_{2 D} [ Y ] ( {τ}_{m , n} ) = \frac{\frac{1}{{N}_{τ}} {\sum }_{ij} ( {y}_{i + {τ}_{m} , j + {τ}_{n}} - μ ) ( {y}_{ij} - μ )}{\frac{1}{{N}_{τ}} {\sum }_{i} {( {y}_{ij} - μ )}^{2}}$$

To derive a single value, root mean square RMS is formed over all τ in one dimension.

$$RMS [ AC ] ( {F}_{l} ) = \frac{1}{{N}_{τ}} {\sum }_{τ} {( AC [ {F}_{l} ] ( τ ) )}^{2}$$

The RMS is formed in two dimensions as follows:

$$RMS [ {AC}_{2 D} ] ( {F}_{l} ) = \frac{1}{{N}_{τ}} {\sum }_{τ} {( {AC}_{2 D} [ {F}_{l} ] ( {τ}_{m , n} ) )}^{2}$$

Feature F of various layers l of network M according to feature representation Fₗ=M(x) results for an at least partially trained network M and a sample x to be assessed. In the example, value RMS[AC](Fₗ) is used as an acquisition function for one dimension. In the example, value RMS[AC_{2D}](Fₗ) is used as an acquisition function for two dimensions. Using the acquisition function for different layers l is possible.

Both equations may be used, regardless of the dimension of the feature space. For a multidimensional feature space, i.e., a dimension>1, this may be attributed to a one-dimensional equation, i.e., to value RMS[AC](Fₗ), by converting a two-dimensional tensor of [symbol] ^{mxn} into a vector, i.e., a one-dimensional tensor having length mxn.

The assessment of the information content by the autocorrelation is not thereby significantly influenced.

Likewise, value RMS[AC](Fₗ) or RMS[AC_{2D}](Fₗ) may be used to assess the extent to which a given situation differs from the training set.

For both applications, it may be advantageous to determine a threshold value, i.e., a reference value, based on one of values RMS[AC](Fₗ), RMS[AC_{2D}](Fₗ) or based on both values. For example, value RMS[AC](Fₗ) is defined based on at least one sample of the training set. For example, value RMS[AC_{2D}](Fₗ) is defined based on at least one sample of the training set.

The method is based on monitored learning. Training data including labels, i.e., annotations, are necessary for monitored learning. These annotations are used as target outputs to allow application of an optimization algorithm. Depending on the application, the creation of such a training data set is very complicated. The labeling of 3D sensor measurements, for example of point clouds that are deliverable by a radar or LIDAR sensor, is very complicated and requires expert knowledge. In addition, in the field of medical imaging it may be very complicated to obtain training data from digital images.

The parameters of model 104, i.e., the deep artificial neural network in the example, may be randomly initialized.

A set of unannotated data is provided in a step 202. The unannotated data include patterns, in the example digital images or their representation. A step 204 is subsequently carried out.

A subset for determining the annotated data is selected from the set of unannotated data in a step 204. The subset includes the acquired unannotated data for the active machine learning.

In a first iteration of the method, the subset is randomly selected from the set of unannotated data in step 204.

Preferably only data that are not already acquired for the subset in a previous iteration are selected from the unannotated data for the subset in step 204.

A step 206 is subsequently carried out.

Annotated data are provided in a step 206. The annotated data may be determined from the subset by manual, semi-automatic, or automatic annotation of unannotated data. For this purpose, for example the digital images are displayed and provided with a label by a human. Automated labeling methods are also usable.

A step 208 is subsequently carried out.

Model 104, the deep neural network in the example, is trained for a classification of the data in step 208 as a function of the annotated data. The training takes place, for example, with the aid of gradient descent methods, for example ADAM, by monitored learning using the annotated data from the subset.

A step 210 is subsequently carried out.

The acquisition function is determined in step 210 as a function of model 104 trained in this way. In the example, values of the acquisition function of the unannotated data are determined for unannotated data. For this purpose, autocorrelation AC is determined from the unannotated data via feature representation F for a sample x to be assessed.

The feature representation is determined from at least one layer of model 104.

The value of the acquisition function of this sample x is determined as a function of root mean square RMS via autocorrelation AC.

In the one-dimensional case, values RMS[AC](Fₗ) are determined from the unannotated data for various samples x. In the two-dimensional case, values RMS[AC_{2D}](Fₗ) are determined from the unannotated data for various samples x. For multidimensional samples x, a reduction of tensors to the one-dimensional or two-dimensional case may be provided; a higher-dimensional autocorrelation may also be used.

A step 212 is subsequently carried out.

The unannotated data for the active machine learning whose values for the acquisition function satisfy a criterion are acquired from the unannotated data in step 212.

In one aspect, samples x whose root mean square RMS exceeds a threshold value are acquired from the unannotated data.

The threshold value is determined, for example, as a function of at least one sample from the annotated data with which model 104 is trained.

Model 104 is preferably iteratively trained.

A check may be made in a step 214 as to whether an abort criterion is satisfied, and the active machine learning is ended when the abort criterion is satisfied.

This means that in the example, steps 202 through 214 are carried out repeatedly in this order or in some other order.

The abort criterion may define a reference for an accuracy of the classification of annotated or unannotated data by the model. The abort criterion is satisfied, for example, when the accuracy of the classification reaches or exceeds the reference.

For example, the method is aborted when 80% of correct predictions are reached.

In a further aspect of the present invention, for a model 104 trained in this way, in particular an artificial neural network M trained in this way, as a function of root mean square RMS it is established via autocorrelation AC whether sample x to be assessed differs from a sample from a training set of samples with which thus-trained model 104 has been trained.

What is claimed is:

1. A computer-implemented method for active machine learning, the method comprising the following steps:
providing annotated data;
training a model for a classification of data as a function of the annotated data;
determining respective values of an acquisition function for unallocated data;
acquiring, from the unallocated data and for the active learning machine, those of the unannotated data whose values for the acquisition function satisfy a criterion; and
determining an autocorrelation using a respective feature representation for each sample from the unallocated data to be assessed for the acquiring step;
wherein the respective value of the acquisition function of each sample is determined as a function of a root mean square using the autocorrelation, in at least one dimension.

2. The method as recited in claim 1, wherein the feature representation is from at least one layer of the model.

3. The method as recited in claim 1, further comprising:
providing a set of unannotated data;
selecting a subset from the set of unannotated data;
wherein the annotated data is determined from the subset by manual, or semi-automatic, or automatic annotation of unannotated data.

4. The method as recited in claim 3, wherein the subset includes the acquired unannotated data for the active machine learning.

5. The method as recited in claim 1, wherein for the sample to be assessed, the autocorrelation is determined via a plurality of feature representations of various layers of the model.

6. The method as recited in claim 1, wherein samples of the unannoted data whose root mean square exceeds a threshold value are acquired from the unannotated data.

7. The method as recited in claim 6, wherein the threshold value is determined as a function of at least one sample from the annotated data with which the model is trained.

8. The method as recited claim 1, wherein the model is iteratively trained, a check being made as to whether an abort criterion is satisfied, and the active machine learning being ended when the abort criterion is satisfied.

9. The method as recited in claim 8, wherein the abort criterion defines a reference for an accuracy of a classification of annotated or unannotated data by the model, the abort criterion being satisfied when the accuracy of the classification reaches or exceeds the reference.

10. The method as recited in claim 8, wherein unannotated data are randomly selected in a first iteration of the method for a determination of the annotated data.

11. The method as recited in claim 3, wherein only data that are not already acquired for the subset are selected from the unannotated data for the subset.

12. The method as recited in claim 1, wherein for the trained model, as a function of the root mean square, it is established via the autocorrelation whether the sample to be assessed differs from a sample from a training set of samples with which the trained model has been trained.

13. The method as recited in claim 12, wherein the trained model is an artificial neural network.

14. A device for active machine learning, the device configured to:
provide annotated data;
train a model for a classification of data as a function of the annotated data;
determine respective values of an acquisition function for unallocated data;
acquire, from the unallocated data and for the active learning machine, those of the unannotated data whose values for the acquisition function satisfy a criterion; and
determine an autocorrelation using a respective feature representation for each sample from the unallocated data to be assessed for the acquisition;
wherein the respective value of the acquisition function of each sample is determined as a function of a root mean square using the autocorrelation, in at least one dimension.

15. A non-transitory computer-readable storage medium on which is stored a computer program including computer-readable instructions for active machine learning, the instructions, when executed by a computer, causing the computer to perform the following steps:
providing annotated data;
training a model for a classification of data as a function of the annotated data;
determining respective values of an acquisition function for unallocated data;
acquiring, from the unallocated data and for the active learning machine, those of the unannotated data whose values for the acquisition function satisfy a criterion; and
determining an autocorrelation using a respective feature representation for each sample from the unallocated data to be assessed for the acquiring step;
wherein the respective value of the acquisition function of each sample is determined as a function of a root mean square using the autocorrelation, in at least one dimension.
